(19) United States
(12) Patent Application Publication
(10) Pub. No.: US 2008/0168298 A1
(43) Pub. Date: Jul. 10, 2008

(54) Methods and Apparatus for Calibrating Heterogeneous Memory Interfaces

(76) Inventors: Mark David Bellows, Rochester, MN (US); Paul Allen Ganfield, Rochester, MN (US); David Alan Norgaard, Rochester, MN (US); Ibrahim Abdel-Rahman Ouda, Rochester, MN (US); Tolga Ozguner, Rochester, MN (US)

Correspondence Address: Matthew C. Zehrer, Agent;Dept. 917, IBM Corporation, 3605 Hwy. 52 North, Rochester, MN, 55901, US

(21) Appl. No.: 11/620,104

(22) Filed: Jan. 5, 2007

(51) Int. Cl. G06F 12/00; G06F 1/08

(52) U.S. Cl. 713/601; 711/100; 711/E12.001

(57) ABSTRACT

In a first aspect, a first method of interfacing a processor and memory is provided. The first method includes the steps of (1) providing a computer system including (a) a memory; (b) a processor adapted to issue a functional command to the memory; (c) a translation chip; (d) a first link adapted to couple the processor to the translation chip; and (e) a second link adapted to couple the translation chip to the memory; (2) calibrating the first link using the translation chip; and (3) while calibrating the first link, calibrating the second link using the translation chip. Numerous other aspects are provided.

### FIELD OF THE INVENTION

The present invention relates generally to computer systems, and more particularly to methods and apparatus for interfacing a processor and a memory.

### BACKGROUND

A conventional computer system may include a processor coupled to a dual data rate (DDR) memory (e.g., SDRAM) via a memory interface, such as a DDR link. DDR memory is cheaper than other memory, such as an extreme data rate (XDR) memory, and/or has a higher storage capacity than such other memory. More specifically, XDR memory is limited in the amount of memory capacity it may support and is more expensive than DDR 2 or DDR 3 memory. However, the DDR link may be slower than other links (e.g., an extreme input/output (XIO) link). A width of the DDR link may be increased (e.g., to 288 bits) to match the bandwidth thereof. Therefore, the DDR link may consume a large number of processor pins to couple to the processor. By requiring the processor to include a large number of pins, the DDR link may cause an increase in size of the processor and cost associated therewith.

A second conventional computer system may include a processor coupled to an extreme data rate (XDR) memory via a memory interface, such as an XIO link. As described above, XDR memory is more expensive and has less storage capacity than DDR memory. However, the XIO link may be a fast, narrow link (e.g., 72 bits wide). Therefore, the XIO link may consume fewer pins on a processor to couple thereto than the DDR link. Consequently, the XIO link may enable a size of the processor and cost associated therewith to be reduced.

As described above, the DDR link coupled to the processor of the first conventional computer system may cause an increase in the size of the processor and cost associated therewith. Further, the XDR memory included in the second conventional computer system may be more expensive than other memory and may have less storage capacity than such other memory. Accordingly, improved methods, apparatus and systems for interfacing a memory and a processor are desired.

### SUMMARY OF THE INVENTION

In a first aspect of the invention, a first method of interfacing a processor and memory is provided. The first method includes the steps of (1) providing a computer system including (a) a memory; (b) a processor adapted to issue a functional command to the memory; (c) a translation chip; (d) a first link adapted to couple the processor to the translation chip; and (e) a second link adapted to couple the translation chip to the memory; (2) calibrating the first link using the translation chip; and (3) while calibrating the first link, calibrating the second link using the translation chip.

In a second aspect of the invention, a first apparatus for interfacing a processor and a memory of a computer system is provided. The first apparatus includes a translation chip adapted to couple to the processor via a first link and to the memory via a second link. The translation chip has (1) first logic adapted to calibrate the first link; and (2) second logic adapted to calibrate the second link while the first logic calibrates the first link.

In a third aspect of the invention, a first system for interfacing a processor and a memory of a computer system is provided. The first system includes (1) a memory; (2) a processor adapted to issue a functional command to the memory; (3) a translation chip; (4) a first link adapted to couple the processor to the translation chip; and (5) a second link adapted to couple the translation chip to the memory. The translation chip is adapted to (a) calibrate the first link; and (b) while calibrating the first link, calibrate the second link. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE FIGURES

FIG. 1 is a block diagram of a system for interfacing a memory and a processor in accordance with an embodiment of the present invention.

FIG. 2 illustrates a method for interfacing a memory and a processor in accordance with an embodiment of the present invention.

### DETAILED DESCRIPTION

The present invention provides improved methods, apparatus and systems for interfacing a memory and a processor. For example, the present invention may provide a translation chip that couples a processor to a DDR memory (e.g., SDRAM) of a computer system. More specifically, the computer system may include an XIO link that couples the processor to the translation chip. Further, the computer system may include a DDR link that couples the translation chip to the DDR memory. The translation chip may be adapted to convert an XDR memory command issued by the processor to a DDR memory command which may be received by the DDR memory. By coupling an XIO link to the processor, the present methods, apparatus and systems may reduce a size of the processor and cost associated therewith. Further, by employing DDR memory, the present methods, apparatus and systems may employ an inexpensive memory having a high storage capacity (compared to other types of memory).

The present invention may periodically calibrate the XIO link and DDR link such that the processor may successfully read data from, write data to, and/or refresh the DDR memory. For example, a delay associated with a clock signal transmitted on the XIO link may be adjusted. Additionally or alternatively, the strength of one or more signals transmitted on the XIO link may be adjusted. Further, the present invention may calibrate the DDR link while calibrating the XIO link. More specifically, when the XIO link is being calibrated, functional memory commands (e.g. a memory read command) are not transmitted to the DDR memory. Consequently, by calibrating the DDR link while calibrating the XIO link, the DDR link calibration will not be interrupted by a functional memory command. The DDR link calibration may include adjusting a position in time of a clock signal employed to capture a data signal relative to a time period when such data signal is valid such that the data signal may be successfully stored. In this manner, the present invention provides improved methods, apparatus and systems for interfacing a memory and processor. More specifically, the present invention may provide seamless calibration of heterogeneous memory interfaces.

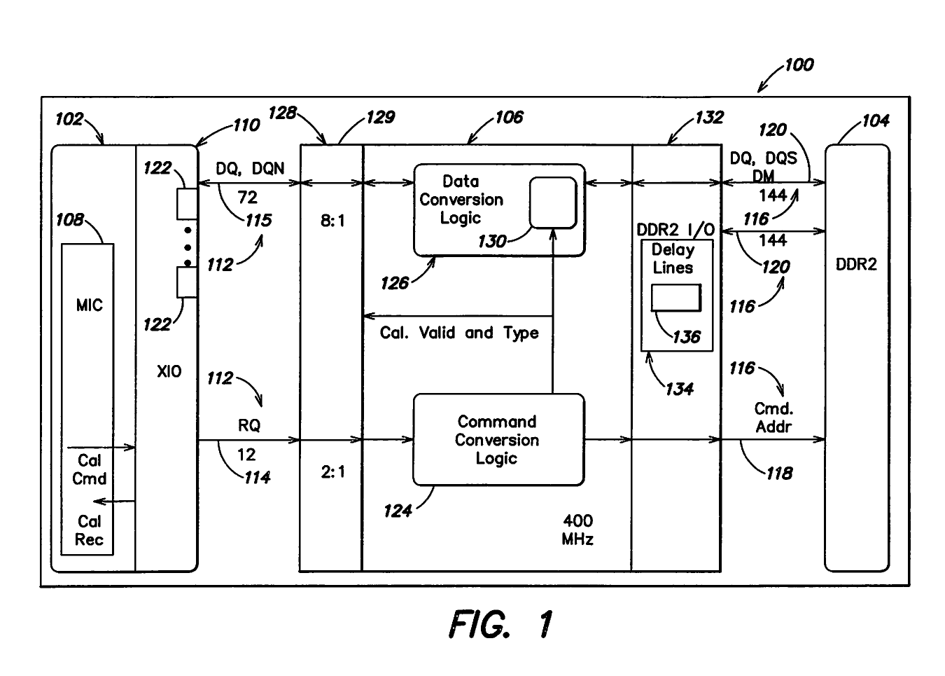

FIG. 1 is a block diagram of a system 100 for interfacing a memory and a processor in accordance with an embodiment of the present invention. With reference to FIG. 1, the system 100 may be a computer or similar device. The system 100 may include a processor 102 coupled to a memory 104 via a translation chip 106. The processor 102 may be adapted to issue functional commands, such as a read, write and/or the like, to the memory 104. The commands issued by the processor 102 may be of a first type. The translation chip 106 may be adapted to receive a command of the first type, translate such command to a command of a second type and forward the command of the second type to the memory 104. More specifically, the processor 102 may include and/or be coupled to a memory interface controller (MIC) 108 adapted to control the flow of data to and from the memory 104. The MIC 108 may be coupled to a first memory interface 110. The first memory interface 110 may be included in and/or coupled to the processor 102. In some embodiments, the first memory interface 110 may be an extreme input/output (XIO) interface. Typically, a processor employs an XIO interface to couple directly to an XDR memory, (e.g., manufactured by Rambus, Inc. of Los Altos, Calif.). However, because XDR memory may be expensive and typically has less storage than other memories, the present system 100 may employ a different type of memory 104. For example, the memory 104 may be a dual data rate (DDR) memory (e.g., a DDR2 or DDR3 memory), which may be less expensive and/or have more storage capacity than XDR memory.

However, the first memory interface 110 may not be adapted to couple directly to the DDR memory 104. Therefore, the first memory interface 110 may be coupled, via a first link 112, to the translation chip 106, which may translate a command of a first type received by the processor 102 to a command of a different type which may be received by the memory 104. The first link 112 may be a narrow, fast link such as an XIO link. An XIO link may provide high bandwidth to the memory by enabling eight bits of data to be sent on each of a plurality of lines in the link per clock cycle from the MIC 108 to the translation chip 106. Consequently, the XIO link may be capable of achieving signal rates of at least 3.2 Gbps, which may allow the MIC 108 and/or processor 102 coupled thereto to use fewer I/O, and therefore, save on die size and cost. More specifically, in some embodiments, the first link 112 may include a 12-bit command bus 114 and a 72-bit data bus 115. However, the command bus 114 and/or data bus 115 may be wider or narrower. The command bus 114 may be adapted to transmit read, write, refresh and/or similar commands thereon. For example, the command bus 114 may be adapted to transmit command signal RQ and/or the like. The data bus 115 may be adapted to transmit data signals DQ, DQN and/or the like. Signals RQ, DQ, DQN are known to a person of skill in the art, and therefore, are not described in detail herein. Because the first link 112 is fast and narrow, a reduced number of processor pins 122 may be required to couple to the link 112. For example, seventy-two processor pins 122 may be required to couple to the data bus 115. Consequently, an overall number of pins 122 included in the processor 102 may be reduced (compared to the number of pins required to couple a different type of link). Therefore, a size of the processor 102 and cost associated therewith may be reduced.

Thus, the translation chip 106 may couple to a processor 106, which executes an application requiring access to a large amount of memory, via an XIO interface and XIO link. The translation chip 106 may receive XDR command and data protocols and convert such command and data protocol to DDR 2 or DDR 3 command and data protocols. By coupling the XIO link to the DDR memory, the translation logic 106 provides the system 100 with the advantage of using the XIO link (e.g., fewer pins consumed on an expensive processor 102) and the advantage of using DDR memory (e.g., low cost and high storage capacity).

As described in detail below, the translation chip 106 may receive the command of the first type from the processor 102 via the first link 112 and convert such command to a command of the second type. Further, the translation chip 106 may be coupled to the memory 104 via a second link 116. The second link may be a link that is slower than the first, such as a DDR link. However, the second link 116 may be wider than the first link 112 (e.g., so the bandwidth of the second link 116 matches that of the first). The command bus 118 may be adapted to transmit commands of the second type and an address associated therewith to the memory 104. The data bus 120 may be adapted to transmit data signals DQ, DQ strobe (DQS), data mask (DM) and/or the like. Signals DQ, DQS, DM are known to a person of skill in the art, and therefore, are not described in detail herein. Therefore, the translation chip 106 may be adapted to receive data bits from a 72-bit bus 116 and transmit the data bits on a 288-bit bus 120. In some embodiments, the translation chip 106 may operate at 400 MHz (although the system 100 may operate at a faster or slower clock speed).

The translation chip 106 may be adapted to perform a function, such as deserialization or the like, on bits received from the processor 102. For example, the translation chip 106 may perform a 2:1 deserialization of command bits received from the command bus 114 and an 8:1 deserialization of data bits received from the data bus 115.

The translation chip 106 may include command conversion logic 124 adapted to convert the command of the first type (e.g., a 2:1 deserialized version thereof) received by the translation chip 106 to a command of the second type to be transmitted from the translation chip 106. The command conversion logic 124 may be adapted to reformat the command of the first type to a command of the second type. For example, the command conversion logic 124 may reformat an extreme data rate (XDR) command received from the processor 102 to a DDR command by translating and synchronizing the received command. The command conversion logic 124 may translate an address associated with the XDR command to an address associated with a DDR command. Additionally, the command conversion logic 124 may synchronize the received command so that the command meets the timing requirements of the DDR memory. In this manner, a command of the first type (and an address associated therewith) may be converted to a command of the second type (and an address associated therewith).

The translation chip 106 may include data conversion logic 126 adapted to convert data bits associated with the command of the first type received by the translation chip 106 to data bits associated with the command of the second type to be transmitted from the translation chip 106. For example, the data conversion logic 126 may translate (e.g., reformat) XDR data bits of the first command into DDR data bits of the second command. In this manner, the data conversion logic 126 may control flow of data bits through the translation chip 106. To convert data associated with the command of the first type received from the processor 102 to data associated with the command of the second type, the data conversion logic 126 may serial or deserialize the data associated with the command of the first type to form the data associated with the command of the second type. For example, the data conversion logic 126 may receive 72 bits of data associated with an XDR command and form 288 bits of data associated with a DDR command.

In this manner, the system 100 may employ the narrow, fast first link 112 to reduce a size and/or cost associated with the processor 102 coupled thereto. Further, the system 100 may employ an inexpensive memory 104 having a large storage capacity. In some embodiments, the system 100 may receive an initial calibration. For example, current and/or impedance calibrations may be performed on the memory interface 110 during system initialization. Further, current and/or impedance calibrations may be performed on the receive side 128 (e.g., receivers and drivers included therein) of the translation logic 106 during system initialization. However, calibration of the memory interface 110 and/or receive side 128 of the translation logic 106 may be performed at a different time. The above-described current and/or impedance calibrations may include adjusting strength of one or more signals output from and/or received by the memory interface 110 and/or the translation logic 106. Further, a timing of one or more signals transmitted on the first link 112 may be calibrated during system initialization. Similarly, a timing of one or more signals transmitted on the second link 116 may be calibrated during system initialization. However, the timing calibration of the first and/or second link 112, 116 may be performed at a different time. The timing calibration of the second link 116 may include adjusting a position in time of (e.g., centering) a clock signal employed to capture a data signal relative to a period of time when such data signal is valid. More specifically, calibration of the second link 116 may include centering of the receive strobe on the data eye. However, timing calibration of the second link 116 may include a larger or smaller number of and/or different type of signal adjustment. Further, the timing calibration of the second link 116 may include adjustments to a larger number of signals.

Once the system 100 is initially calibrated, the system 100 may be employed to perform a read, write, refresh and/or similar operation on the memory 104. However, when the system 100 is employed to perform such memory operations, operational conditions may cause one or more of the links 112, 116 (along with other components included in the system 100) to require calibration (e.g., especially a link operating a high speed). Therefore, the translation logic 106 may include first calibration logic 129 adapted to perform one or more of calibration of the first memory interface 110, receive side 128 of the translation logic 106 and/or the first link 112. Such calibration may be performed periodically. Alternatively, such calibration may be performed on demand based on operational conditions of the system 100. These periodic calibrations may be requested by the XIO interface 110, and the MIC 108 in turn will send the appropriate command to the XIO interface 110. For example, such calibration command may be sent off the processor 102 into the translation chip 106. More specifically, during operation, the first memory interface 110 may issue a request for calibration Cal Req to the MIC 108. In response, the MIC 108 may issue a calibration command Cal Cmd on the first link 112 which may cause the first calibration logic 129 to calibrate the first memory interface 110, receive side 128 of the translation logic 106 and/or the first link 112. During such calibration, the command conversion logic 124 may be adapted to receive commands from the first link 112, determine calibration of the first link 112 is requested and notify the receive side 128 that calibration of the first link 112 should begin. Additionally, the command conversion logic can notify the data conversion logic and the delay line logic 134 that the first link 112 is being calibrated and that the second link 116 can be calibrated concurrently.

Calibration of the second link 116 may be performed during memory refresh operations. An XIO interface of a conventional system may be coupled to an XDR DRAM. In the conventional system, the XIO interface may issue a separate command to refresh each bank of the XDR memory individually. The XIO interface 110 of the present invention may employ the same type of memory bank refresh commands as the XIO interface in the conventional system. Such a memory bank refresh command may have the same length and format as other commands that may be issued on the XIO link 112. Such memory bank refresh command may be interleaved with other functional commands (e.g., a read command). Thus, instead of relying on a single long multiple-bank refresh command, the XIO interface 110 may issue multiple single memory bank refresh commands on the XIO link 112. The translation chip 106 may calibrate the second link 116 during a time period required to perform the memory bank refresh command. Each such single memory bank refresh command on the XIO link 112 may be easy to detect. Further, a time period required to perform the single memory bank refresh may be unlike any other potential gap in a read command. However, the duration of each single memory bank refresh command is shorter than that of a single multiple-bank refresh command (e.g., employed by the processor in the first conventional computer system to refresh the DDR memory). Thus, such duration may not be sufficient for the second link 116 to be calibrated during a single memory bank refresh command.

To further deal with unwanted calibration changes caused by system operational conditions, the translation logic 106 may include second calibration logic 130 adapted to perform a timing calibration on the second link 116 (e.g., a DDR link or interface). For example, assume as the system 100 (e.g., processor 102 included therein) heats up logic elements which are employed by the system 100 to adjust (e.g., center) a clock signal relative to a window in which a data signal corresponding thereto is valid may slow down. Thus, an edge of the clock signal may move later in time with respect to the data signal. The second calibration logic 130 may be adapted to calculate an adjustment (e.g., delay) to a data signal to be issued on the second link 116 such that the clock signal is properly positioned (in time) relative to a time period when the data signal associated with the command of the second type is valid. For example, the second calibration logic 130 may calculate an adjustment to a receive strobe on the data eye. In this manner, an actual delay through the delay elements may be measured periodically and adjusted to preserve strobe centering relative to the data.

In some embodiments, the second calibration logic 130 may be included in the data conversion logic 126 (although the second calibration logic 130 may be located elsewhere). Additionally, the translation chip 106 may include an interface 132 to the memory 104 adapted to perform memory input/output (I/O). The interface 132 may receive the command of the second type and an address associated therewith from the command conversion logic 124. Further, the interface 132 may receive data associated with the command of the second type from the data conversion logic 126. The interface 132 may be adapted to transmit the command of the second type and address and/or data associated therewith to the memory 104 via the second link 116. The interface 132 may include one or more delay lines or chains 134 each of which may include one or more delay books 136. A delay book 136 may represent a unit of delay. Based on the adjustment calculated by the second calibration logic 130, the memory interface 132 may adjust a relative position of a clock signal to be transmitted on the second link 116. More specifically, the memory interface 110 may cause the data signal to be transmitted on the second link 116 with the command of the second type and address associated therewith to travel through one or more or the delay books 136 and/or lines 134 such that the data signal is delayed long enough that the clock signal is properly repositioned relative to a time period when the data associated with the command of the second type is valid.

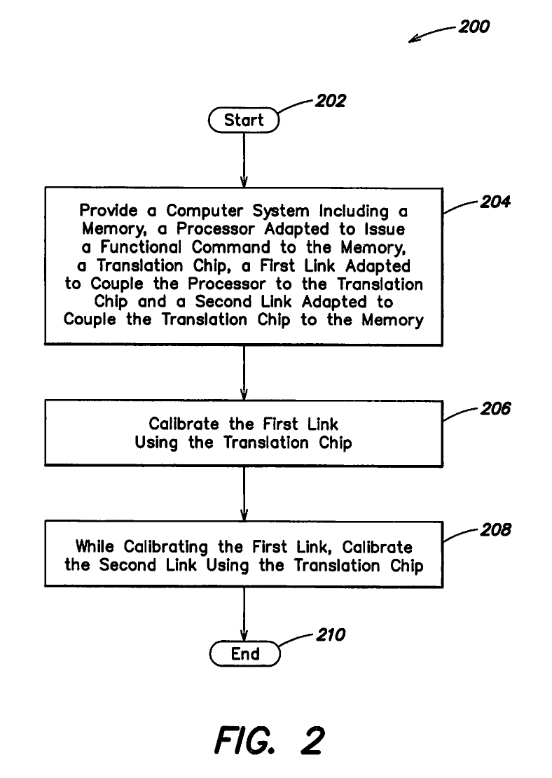

Operation of the system 100 for interfacing a memory and a processor is now described with reference to FIG. 2 which illustrates a method for interfacing a memory and a processor in accordance with an embodiment of the present invention. With reference to FIG. 2, in step 202, the method 200 begins. In step 204, a computer system 100 including a memory 104, a processor 102 adapted to issue a functional command to the memory 104, a translation chip 106, a first link 112 adapted to couple the processor 102 to the translation chip 106 and a second link 116 adapted to couple the translation chip 106 to the memory 104 may be provided. The first link may be a narrow, fast link adapted to transmit commands of a first type along with an address and/or data associated therewith from the processor 102 to the translation chip 106. The translation chip 106 may be adapted to receive the command of the first type along with an address and/or data associated therewith and convert such information to a command of a second type with addresses and/or data associated therewith. The second link 116 may be a wide, slow link adapted to transmit the command of the second type along with an associated address and/or data from the translation chip 106 to the memory 104.

For example, the processor 102 may include and/or be coupled to an extreme input/output (XIO) memory interface 110 adapted to control flow of data to and from an extreme data rate (XDR) memory. The first link 112 may be an XIO link which couples the XIO interface 110 to the translation chip 106. Further, the memory 104 may be a DDR SDRAM and the second link 116 may be a DDR link adapted to couple the translation chip 106 to the DDR memory. Therefore, the translation chip 106 may be adapted to receive an XDR memory command via an XIO link 112, convert such command to a DDR memory command and transmit the DDR memory command to the DDR memory 104 via a DDR link 116. Consequently, such system 100 benefits from the advantages of employing DDR memory and an XIO link coupled directly to the processor 102 while avoiding the disadvantages of employing an XDR memory and a DDR link directly coupled to a processor 102.

To ensure the system 100 may successfully perform functional memory operations, such as a memory read, write, refresh and/or the like, the system 100 may initially be calibrated (e.g., during system initialization). For example, a timing of one or more signals transmitted on the first link 112 may be calibrated. Similarly, a timing of one or more signals transmitted on the second link 116 may be calibrated during system initialization. The timing calibration of the second link 116 may include adjusting (e.g., centering) a clock signal employed to capture a data signal relative to a period of time when such data signal is valid. Additionally, current and/or impedance calibrations (e.g., impedance matching) may also be performed on the memory interface 110.

However, during system operation, a change in operational conditions, such as an increase in system temperature, a fluctuation of current through the system and/or the like, may cause an unwanted change in system calibration. For example, a timing of one or more signals (e.g., clock signals) transmitted on the first and/or second links 112, 116 may change. More specifically, the change in operational conditions may cause a clock signal transmitted on a link 112, 116 and employed to capture a data signal transmitted on the link 112, 116 to be delayed. The delay may cause the clock signal to be improperly positioned in time relative to a time period when the data signal is valid. Additionally, the change in operational conditions may cause a strength of one or more signals output from the memory interface 110 and/or received in a receive side 128 of the translation logic 106 to change. Thus, impedance of the memory interface 110 may need to be matched with the impedance on the distal end of the link 112 coupled thereto. Additionally or alternatively, impedance of the receive side 128 of the translation logic 106 may need to be matched with the impedance on the distal end of the link 112 coupled thereto.

Calibration of the first link 112 may require five different types of periodic calibrations, current and impedance calibrations for the XIO interface 110, current and impedance calibrations for the translation chip 106, as well as a timing calibration (e.g., delay adjustments) for the signals transmitted on the XIO link 112.

The unwanted calibration change caused by the operational conditions may prevent the system 100 from successfully performing a functional memory operation. Therefore, to account for the change in operational conditions, the system 100 may calibrate (e.g., re-calibrate) itself periodically or sporadically. In some embodiments, the system 100 may calibrate itself on demand. For example, in step 206, the first link 112 may be calibrated using the translation chip 106. The memory interface 110 may be adapted to detect a change in system operating conditions. Consequently, the memory interface 110 may issue a calibration request to the memory interface controller (MIC) 108. In response, the MIC 108 may issue a calibration command to the translation chip 106 via the first link 112. The translation chip 106 may decode the command and send the decoded information to the first calibration logic 129 and second calibration logic 130. Consequently, the first calibration logic 129 may recalibrate the timing of one or more signals transmitted on the first link 112 such that data transmitted on the first link 112 may be properly captured by the translation logic 106.

Additionally or alternatively, the first calibration logic 129 may perform current and/or impedance calibrations on the memory interface 110 and/or the receive side 128 of the translation logic 106 again. For example, impedance matching may be performed on the memory interface 110 and/or the receive side 128 of the translation logic 106 again. In this manner, the first link 112, MIC 108 and/or receive side 128 translation logic 106 may be calibrated such that a command of the first type along with data and/or an address associated therewith may successfully be transmitted from the processor 102 to the translation chip 106.

The calibration of the first link 112 may be performed in between (e.g., interleaved with) functional memory commands of the first type, such as a read, write, refresh and/or the like. Therefore, while the first calibration logic 129 calibrates the first link 112, the processor 102 may be prevented from issuing a functional memory command. For example, while the first link 112 is being calibrated, the MIC 108 may not send any other traffic on the link for a predetermined time period (e.g., about 64 command clock cycles, which may be about 160 ns). Consequently, the system 100 may be assured that the memory 104 will not be accessed for a functional operation while the first link 112 is calibrated. Therefore, in step 208, while calibrating the first link 112, the second link 116 may be calibrated using the translation chip 106 (e.g., using the second calibration logic 130 included therein). As stated, the translation chip 106 may send the decoded information to the second calibration logic 130. In this manner, the second calibration logic 130 may be notified when the first link 112 is being calibrated. By performing the calibration of the second link 116 while calibrating the first link 112, the system 100 may also be assured that calibration of the second link 116 will not be interrupted by a functional memory command requiring memory access.

During calibration of the second link 116, a timing of one or more signals transmitted on the second link 116 may be adjusted. The timing calibration of the second link 116 may include adjusting a clock signal employed to capture a data signal relative to a period of time when such data signal is valid. For example, a clock signal transmitted on the second link 116 may be repositioned in time relative to a time period when a data signal transmitted on the second link 116 is valid. More specifically, the receive strobe may be centered on the data eye. To adjust the clock signal in the above-described manner, the second calibration logic 130 may calculate an adjustment to the data signal associated with the command of the second type that is to be transmitted on the second link 116. For example, assume as operational conditions change (e.g., one or more components of the system 100 heat up), a clock signal to be transmitted on the second link 116 and employed to capture a data signal transmitted on the second link 116 is delayed. Consequently, such clock signal may need to be properly repositioned relative to the data signal to be transmitted on the second link 116. The clock signal may be repositioned relative to the data signal by delaying the data signal by an amount calculated by the second calibration logic 130. To calculate the adjustment to the data signal, an amount by which a delay through the books 136 has changed since system initialization or since a previous calibration of the second link 116 may be determined. The change in delay through the books 136 may be determined by varying the delay settings around a current full cycle delay value and sending pulses down one or more of the delay chains 134 to measure the amount of delay in a full cycle. The adjustment to the data signal may be calculated based on such transmission of pulses down the one or more delay chains 134. However, a different method may be employed to calculate the adjustment to the data signal. Because the second link 116 is calibrated while the first link 112 is calibrated, and functional memory commands may not be received by the memory 104 during calibration of the first link 112, the second calibration logic 130 may have enough time to calculate the adjustment to the data signal.

The translation chip 106 may delay the data signal by the calculated amount by changing (e.g., increasing) a logic path through which the data travels to reach the memory 104. For example, the translation chip 106 may employ one or more delay books 136 included in the delay lines 134 to increase the logic path of the data signal to the memory 104, thereby delaying the data signal by the amount calculated by the second calibration logic 130. Although delay books 136 and/or delay lines 134 are employed to delay the data signals, the delay may be introduced in a different manner. For example, different logic may be employed to adjust the data signal. In this manner, the second link 116 may be recalibrated such that the command of the second type and addresses and/or data associated therewith may be successfully transmitted to the memory 104.

Thereafter, step 210 may be employed. In step 210, the method 200 ends. Through use of the method 200, a processor 102 adapted to issue commands of a first type (e.g., XDR commands) and a memory 104 adapted to receive commands of a second type (e.g., DDR commands) may be interfaced via a translation chip 106 such that the memory 104 may successfully receive functional commands issued by the processor 102. The processor 102 may be coupled to the translation chip 106 via a first link 112, and the translation chip 106 may be coupled to the memory 104 via a second link 116. The translation chip 106 may convert the command of the first type to the command of the second type. Further, the translation chip 106 may periodically or sporadically calibrate the two high-speed interfaces (e.g., the first and/or second link 112, 116) to account for changes in a previous system calibration caused by a change in system operational conditions such that the processor 102 may continue to successfully read data from and/or write data to the memory 104. The present methods and apparatus provide versatility, because the system 100 may easily adapt to a change in memory type. For example, the translation chip 106 may be modified to convert commands of the first type to commands of a type that the new memory may understand.

The foregoing description discloses only exemplary embodiments of the invention. Modifications of the above disclosed apparatus and methods which fall within the scope of the invention will be readily apparent to those of ordinary skill in the art. For instance, as described above, calibration of the first link 112 may include one or more of memory interface calibration, translation logic receive side 128 calibration and timing calibration of one or more signals transmitted on the first link 112. Similarly, as described above, calibration of the second link 116 may include a timing calibration of one or more signals transmitted on the second link 116. However, the above calibrations are exemplary. Therefore, calibration of the first and/or second link 112, 116 may include a larger or smaller number of and/or different types of calibrations.

Accordingly, while the present invention has been disclosed in connection with exemplary embodiments thereof, it should be understood that other embodiments may fall within the spirit and scope of the invention, as defined by the following claims.

The invention claimed is:

1. A method of interfacing a processor and memory, comprising:
providing a computer system including:
a memory;
a processor adapted to issue a functional command to the memory;
a translation chip;
a first link adapted to couple the processor to the translation chip; and
a second link adapted to couple the translation chip to the memory;
calibrating the first link using the translation chip; and
while calibrating the first link, calibrating the second link using the translation chip

2. The method of claim 1 wherein:
calibrating the first link includes adjusting at least one of a delay associated with a signal transmitted on the first link and a strength of one or more signals transmitted on the first link; and
calibrating the second link includes adjusting a position in time of a clock signal to be transmitted on the second link and employed to capture a data signal relative to a time period when such data signal is valid such that the data may be successfully stored.

3. The method of claim 2 wherein adjusting the position in time of the clock signal to be transmitted on the second link and employed to capture the data signal relative to the time period when such data signal is valid such that the data signal may be successfully stored includes increasing or decreasing a logic path to the memory employed by the data signal, and wherein the signal transmitted on the first link is at least one of a clock signal and a data signal.

4. The method of claim 1 further comprising employing the translation chip to convert a memory command of a first type issued from the processor to a memory command of a second type received by the memory.

5. The method of claim 1 wherein:
the memory is a double data rate (DDR) memory;
the first link is an extreme input/output (XIO) link; and
the second link is a DDR link.

6. The method of claim 1 wherein calibrating the first link includes preventing the memory from receiving a functional command.

7. The method of claim 1 wherein calibrating the first link includes calibrating the first link in response to a calibration command from the processor.

8. An apparatus for interfacing a processor and a memory of a computer system, comprising:
a translation chip adapted to couple to the processor via a first link and to the memory via a second link;
the translation chip having:
first logic adapted to calibrate the first link; and
second logic adapted to calibrate the second link while the first logic calibrates the first link.

9. The apparatus of claim 8 wherein:
the first logic is further adapted to calibrate at least one of a delay associated with a signal transmitted on the first link and a strength of one or more signals transmitted on the first link; and
while the first logic calibrates at least one of the delay associated with the signal transmitted on the first link and the strength of one or more signals transmitted on the first link, the second logic is further adapted to adjust a position in time of a clock signal to be transmitted on the second link and employed to capture the data signal relative to a time period when such data is valid such that the data signal may be successfully stored.

10. The apparatus of claim 9 wherein the second logic is further adapted to increase or decrease a logic path to the memory employed by the data signal to be transmitted on the second link.

11. The apparatus of claim 8 wherein the translation chip is further adapted to convert a memory command of a first type issued from the processor to a memory command of a second type received by the memory.

12. The apparatus of claim 8 wherein the first logic is further adapted to calibrate the first link in response to a calibration command from the processor.

13. A system for interfacing a processor and a memory of a computer system, comprising:
a memory;
a processor adapted to issue a functional command to the memory;
a translation chip;
a first link adapted to couple the processor to the translation chip; and
a second link adapted to couple the translation chip to the memory;
wherein the translation chip is adapted to:
calibrate the first link; and
while calibrating the first link, calibrate the second link.

14. The system of claim 13 wherein the translation chip is further adapted to:
calibrate at least one of a delay associated with a signal transmitted on the first link and a strength of one or more signals transmitted on the first link; and
while calibrating at least one of the delay associated with the signal transmitted on the first link and the strength of one or more signals transmitted on the first link, adjust a position in time of the clock signal to be transmitted on the second link and employed to capture a data signal relative to a time period when such data signal is valid such that the data signal may be successfully stored.

15. The system of claim 14 wherein the translation chip is further adapted to increase or decrease a logic path to the memory employed by the data signal to be transmitted on the second link.

16. The system of claim 13 wherein the translation chip is further adapted to convert a memory command of a first type issued from the processor to a memory command of a second type received by the memory.

17. The system of claim 13 wherein:
the memory is a double data rate (DDR) memory;
the first link is an extreme input/output (XIO) link; and
the second link is a DDR link.

18. The system of claim 13 wherein the translation chip is further adapted to prevent the memory from receiving a functional command while calibrating the first link.

19. The system of claim 13 wherein the translation chip is further adapted to calibrate the first link in response to a calibration command from the processor.

20. The system of claim 14 wherein the signal transmitted on the first link is at least one of a clock signal and a data signal.
